(19) United States
(12) Patent Application Publication
(10) Pub. No.: US 2017/0177839 A1
(43) Pub. Date: Jun. 22, 2017

(54) METHOD AND APPARATUS FOR TRANSFERRING DATA

(71) Applicant: Core Wireless Licensing S.a.r.l., Luxembourg (LU)

(72) Inventors: Christian Rossing Kraft, Frederiksberg (DK); Joakim Christoffersson, Malmo (SE)

(21) Appl. No.: 15/454,035

(22) Filed: Mar. 9, 2017

Related U.S. Application Data
(62) Division of application No. 12/256,943, filed on Oct. 23, 2008.

(51) Int. Cl. G06F 21/10; G06Q 20/12

(52) U.S. Cl. CPC G06F 21/10; G06Q 20/1235

(57) ABSTRACT

In accordance with an example embodiment of the present invention, an apparatus comprises a processor configured to disable a right for at least one media, send a communication for at least one new media, the communication indicating the disabled right of at least one media. Further, the processor is configured to receive the at least one new media.

### TECHNICAL FIELD

The present application relates generally to a method and apparatus for transferring media.

### BACKGROUND

Online media sites allow a user to purchase media, such as music. Typically, the media may be purchased via an electronic device. A user may then listen to the purchased media, e.g., play a song, on the electronic device or computer. Thus, a user may purchase and enjoy a media using a media site.

### SUMMARY

Various aspects of the invention are set out in the claims.

In accordance with an example embodiment of the present invention, an apparatus comprises a processor configured to disable a right for at least one media, send a communication for at least one new media, the communication indicating the disabled right of at least one media. Further, the processor is configured to receive the at least one new media.

In accordance with another example embodiment of the present invention, a method comprises disabling a right for at least one media, sending a communication for at least one new media, the communication indicating the disabled right of at least one media. Further, the method comprises receiving the at least one new media.

In accordance with another example embodiment of the present invention, an apparatus comprises a processor configured to receive a communication for at least one new media, activate a right for the at least one new media, and transfer the at least one new media.

In accordance with another example embodiment of the present invention, a method comprises receiving a communication for at least one new media, activating a right for the at least one new media, and transferring the at least one new media.

In accordance with another example embodiment of the present invention, an apparatus comprises a processor configured to disable a right associated with at least one media and receive at least one credit for the disabled right.

In accordance with another example embodiment of the present invention, a method comprises disabling a right associated with at least one media and receiving at least one credit for disabling the right.

### BRIEF DESCRIPTION OF THE DRAWINGS

For a more complete understanding of example embodiments of the present invention, reference is now made to the following descriptions taken in connection with the accompanying drawings in which:

FIG. 1 is a block diagram depicting an electronic device operating in accordance with an example embodiment of the invention;

FIG. 2 is a block diagram depicting an electronic device and a network entity for transferring media in accordance with an example embodiment of the invention;

FIG. 3A is a flow diagram depicting an example method for activating media in accordance with an example embodiment of the invention;

FIG. 3B is a flow diagram depicting another example method for transferring media in accordance with an example embodiment of the invention;

FIG. 4 is a block diagram depicting an electronic device and another electronic device operating in accordance with an example embodiment of the invention;

FIG. 5A is a flow diagram depicting an example method for receiving media in accordance with an example embodiment of the invention; and

FIG. 5B is a flow diagram depicting another example method for transferring media in accordance with an example embodiment of the invention

### DETAILED DESCRIPTION OF THE DRAWINGS

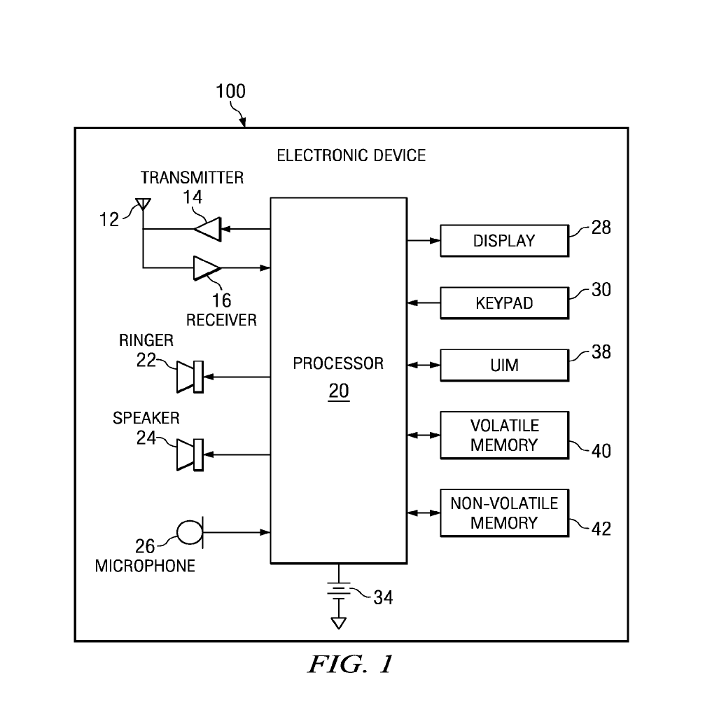

An example embodiment of the present invention and its potential advantages are best understood by referring to FIGS. 1 through 5B of the drawings.

FIG. 1 is a block diagram depicting an electronic device 100 operating in accordance with an example embodiment of the invention. In an example embodiment, an electronic device 100 comprises at least one antenna 12 in communication with a transmitter 14, a receiver 16, and/or the like. The electronic device 100 may further comprise a processor 20 or other processing component. The processor 20 may provide at least one signal to the transmitter 14 and may receive at least one signal from the receiver 16. In an embodiment, the electronic device 100 may also comprise a user interface comprising one or more input or output devices, such as a conventional earphone or speaker 24, a ringer 22, a microphone 26, a display 28, and/or the like. In an embodiment, the one or more output devices of the user interface may be coupled to the processor 20.

In an example embodiment, the user interface allows the electronic device 100 to receive or transmit data. For example, the user interface may comprise any of a number of devices configured to receive data, such as a keypad 30, a touch display, other input device, and/or the like. In an embodiment, the keypad 30 may comprise the conventional numeric, e.g., 0-9, and/or related keys, e.g., #, *, other hard and/or soft keys, and/or the like to operate the electronic device 100. In an alternative embodiment, the keypad 30 may comprise a conventional QWERTY keypad arrangement. Further, the keypad 30 may also comprise various soft keys with associated features. If desired, the electronic device 100 may comprise a user interface device, such as a joystick or the like.

In an embodiment, the electronic device 100 may also comprise a battery 34, such as a vibrating battery pack, for powering various circuits to operate the electronic device 100. Further, the vibrating battery pack may also provide mechanical vibration as a detectable output. In an embodiment, the electronic device 100 may further comprise a user identity module (UIM) 38. In one embodiment, the UIM 38 may be a memory device comprising a processor. The UIM 38 may comprise, for example, a subscriber identity module (SIM), a universal integrated circuit card (UICC), a universal subscriber identity module (USIM), a removable user identity module (R-UIM), and/or the like. Further, the UIM 38 may store one or more information elements related to a subscriber, such as a mobile subscriber.

In an embodiment, the electronic device 100 may comprise memory. For example, the electronic device 100 may comprise volatile memory 40, such as random access memory (RAM). Volatile memory 40 may comprise a cache area for the temporary storage of data. Further, the electronic device 100 may also comprise non-volatile memory 42, which may be embedded and/or may be removable. The non-volatile memory 42 may also comprise an electrically erasable programmable read only memory (EEPROM), flash memory, and/or the like. In an alternative embodiment, the processor 20 may comprise memory. For example, the processor 20 may comprise volatile memory 40, non-volatile memory 42, and/or the like.

In an embodiment, the electronic device 100 may use memory to store any of a number of pieces of information and/or data to implement one or more features of the electronic device 100. Further, the memory may comprise an identifier, such as international mobile equipment identification (IMEI) code, capable of uniquely identifying the electronic device 100. The memory may store one or more instructions for determining cellular identification information based at least in part on the identifier. For example, the processor 20, using the stored instructions, may determine an identity, e.g., cell id identity or cell id information, of a communication with the electronic device 100.

In an embodiment, the processor 20 of the electronic device 100 may comprise circuitry for implementing audio feature, logic features, and/or the like. For example, the processor 20 may comprise a digital signal processor device, a microprocessor device, a digital to analog converter, other support circuits, and/or the like. In an embodiment, control and signal processing features of the processor 20 may be allocated between devices, such as the devices describe above, according to their respective capabilities. Further, the processor 20 may also comprise an internal voice coder and/or an internal data modem. Further still, the processor 20 may comprise features to operate one or more software programs. For example, the processor 20 may be capable of operating a software program for connectivity, such as a conventional Internet browser. Further, the connectivity program may allow the electronic device 100 to transmit and receive Internet content, such as location-based content, other web page content, and/or the like. In an embodiment, the electronic device 100 may use a wireless application protocol (WAP), hypertext transfer protocol (HTTP), file transfer protocol (FTP) and/or the like to transmit and/or receive the Internet content.

In an embodiment, the electronic device 100 may be capable of operating in accordance with any of a number of a first generation communication protocol, a second generation communication protocol, a third generation communication protocol, a fourth generation communication protocol, and/or the like. For example, the electronic device 100 may be capable of operating in accordance with second generation (2G) communication protocols IS-136, time division multiple access (TDMA), global system for mobile communication (GSM), IS-95 code division multiple access (CDMA), and/or the like. Further, the electronic device 100 may be capable of operating in accordance with third-generation (3G) communication protocols, such as Universal Mobile Telecommunications System (UMTS), CDMA2000, wideband CDMA (WCDMA), time division-synchronous CDMA (TD-SCDMA), and/or the like. Further still, the electronic device 100 may also be capable of operating in accordance with 3.9 generation (3.9 G) wireless communication protocols, such as Evolved Universal Terrestrial Radio Access Network (E-UTRAN) or the like, or wireless communication projects, such as long term evolution (LTE) or the like. Still further, the electronic device 100 may be capable of operating in accordance with fourth generation (4G) communication protocols.

In an alternative embodiment, the electronic device 100 may be capable of operating in accordance with a non-cellular communication mechanism. For example, the electronic device 100 may be capable of communication in a wireless local area network (WLAN), other communication networks, and/or the like. Further, the electronic device 100 may communicate in accordance with techniques, such as radio frequency (RF), infrared (IrDA), any of a number of WLAN techniques. For example, the electronic device 100 may communicate using one or more of the following WLAN techniques: IEEE 802.11, e.g., 802.11a, 802.11b, 802.11g, 802.11n, and/or the like. Further, the electronic device 100 may also communicate, via a world interoperability, to use a microwave access (WiMAX) technique, such as IEEE 802.16, and/or a wireless personal area network (WPAN) technique, such as IEEE 802.15, BlueTooth (BT), ultra wideband (UWB), and/or the like.

It should be understood that the communications protocols described above may employ the use of signals. In an example embodiment, the signals comprise signaling information in accordance with the air interface standard of the applicable cellular system, user speech, received data, user generated data, and/or the like. In an embodiment, the electronic device 100 may be capable of operating with one or more air interface standards, communication protocols, modulation types, access types, and/or the like. It should be further understood that the electronic device 100 is merely illustrative of one type of electronic device that would benefit from embodiments of the invention and, therefore, should not be taken to limit the scope of embodiments of the invention.

While embodiments of the electronic device 100 are illustrated and will be hereinafter described for purposes of example, other types of electronic devices, such as a portable digital assistant (PDA), a pager, a mobile television, a gaming device, a camera, a video recorder, an audio player, a video player, a radio, a mobile telephone, a traditional computer, a portable computer device, a global positioning system (GPS) device, a GPS navigation device, a GPS system, a mobile computer, a browsing device, an electronic book reader, a combination thereof, and/or the like, may be used. While several embodiments of the invention may be performed or used by the electronic device 100, embodiments may also be employed by a server, a service, a combination thereof, and/or the like.

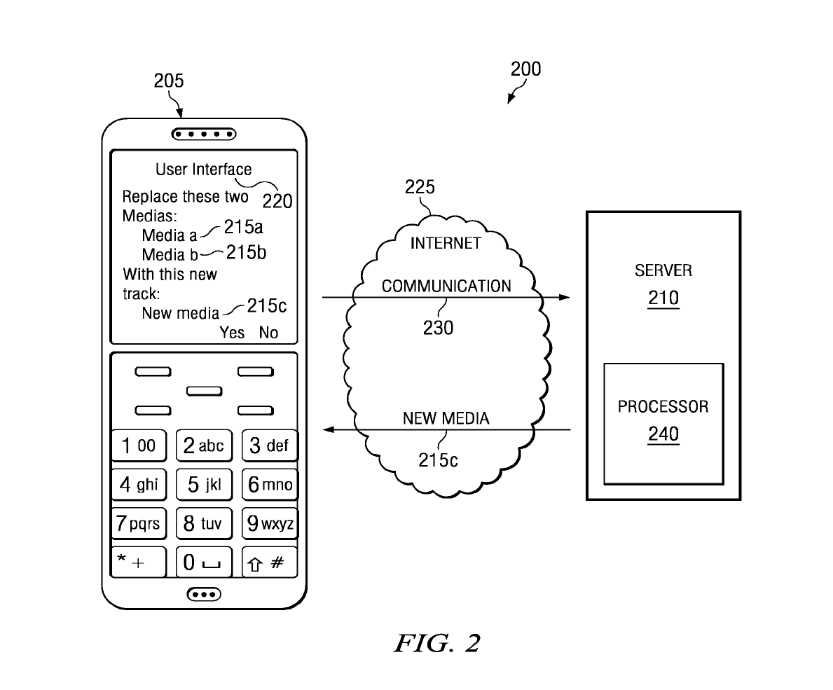

FIG. 2 is a block diagram depicting an electronic device 205 and a network entity, such as server 210, for transferring media in accordance with an example embodiment of the invention. In an embodiment, a network entity may comprise a server 210, an electronic device, and/or the like.

In an example embodiment, the electronic device 205 and the server 210 are in communication, via a network, such as Internet 225. In an embodiment, the electronic device 205 may send a communication 230 to the server 210. In an example embodiment, the communication 230 comprises an identifier for a new media 215c, a payment, a credit, a confirmation of disabling, a name of a media, a fee, a previously earned credit, a half credit and a fee, and/or the like.

In an embodiment, the electronic device 205 may comprise a processor, such as processor 20 of FIG. 1 and/or a user interface 220. In an embodiment, the server 210 may comprise a processor 240 and/or the like. The electronic device 205 and the server 210 may comprise at least one media. In an example embodiment, media 215a-b, new media 215c, and/or the like are at least one of the following: audio, video, software, a combination thereof, and/or the like.

In an example embodiment, the user interface 220 displays at least one media 215a to the user. The user interface 220 may be configured to allow the user to select a new media 215c to exchange for the at least one media 215a-b. For example, the user interface 220 may allow a user to initiate transfer of two or more media, for example, two music files, from the electronic device 205 to the server 210 and to receive a new media from the server 210. In an example embodiment, at least one of the media 215a is the same as the new media 215c.

In an alternative embodiment, the user interface 220 may display at least one media 215a to the user. The user interface 220 may be configured to allow a user to select at least two new media, such as new media 215c, to exchange for the at least one media 215a, 215b. For example, the user interface 220 may allow a user to initiate an exchange of a media, for example, a video from the electronic device 205 to the server 210 and to receive two or more media of the same or different type, for example, two or more music files from the server 210. In an example embodiment, at least one of the media 215a is the same as the new media 215c.

In an alternative embodiment, the user interface 220 may display at least two media 215a-b to the user. The user interface 220 may be configured to allow the user to select at least two new media, such as new media 215c, to transfer for at least two media 215a-b. For example, the user interface 220 may allow the user to initiate a transfer of two or more media, for example, two or more music files from the electronic device 205 to the server 210. The electronic device 205 may receive two or more media, for example, two or more new music files, from the server 210. In an example embodiment, at least one of the media 215a-b is the same as at least one of the new media.

In an example embodiment, the user interface 220 is configured to provide a media identifier to the processor of the electronic device 205 based at least in part on the selection of the at least one media 215a. For example, the user interface 200 provides a media identifier, such as a digital rights management (DRM) identifier, which is associated with media 215a. In an example embodiment, DRM relates to access control technologies used by hardware manufacturers, publishers, copyright holders, and/or the like to limit usage of digital media, electronic devices, and/or the like. In an embodiment, a DRM right may be one or more of the following: forward-lock, combined delivery, separate delivery, and/or the like.

In an example embodiment, the processor is configured to receive at least one media identifier for at least one media. For example, the processor receives the DRM identifier for media 215a. Further, the processor may be configured to disable a right associated with each of the at least one media identifier. For example, the processor disables the DRM right, such as forward-lock, to render media 215a inoperable or unusable. A possible technical effect may be disabling a digital rights management right.

In an embodiment, the processor of the electronic device 205 may be configured to send a communication 230 for the new media 215c, via the Internet 225, to the server 210. For example, the processor sends the communication 230 comprising a new media identifier and/or a confirmation of disabling at least one media, such as media 215a and media 215b. In an alternative embodiment, the processor may send communication 230 comprising a payment to the server 210 and/or a confirmation of disabling a single media, such as media 215a. In yet another alternative embodiment, the processor may transfer a credit to the server 210 for the new media 215c. In still yet another alternative embodiment, the processor may store a credit to the server 210 associated with a user of the electronic device 205.

In an embodiment, the processor 240 of the server 210 may be configured to receive a communication 230 comprising a new media identifier for the new media 215c. In an alternative embodiment, processor 240 of the server 210 may be configured to receive the communication 230 comprising a payment for the new media 215c. In yet another alternative embodiment, processor 240 of the server 210 may be configured to receive the communication 230, where the communication 230 may comprise a credit to be applied in exchange for the media 215c. In still yet another alternative embodiment, the server 210 may apply a stored credit associated with the user of the electronic device 205. It should be understood that the communication 230 may comprise any number of combinations of information.

In an embodiment, the server 210 may be part of a social networking web site. The social networking web site may allow users to exchange media. Further, the social networking web site may allow a user to create a list of media to exchange. In an embodiment, the social networking web site may publish the list of media to specific contacts, such as friends, or to all users. In an embodiment, the social networking web site may provide the listing of media with an icon, a graphical indicator, an audio indicator, and/or the like to indicate a desire to exchange.

In an embodiment, the users may also search for possible media to obtain via an exchange. For example, a user could perform a search “Who of my friends would be willing to exchange song A for song B?” In such a case, the social networking web site may list the users who have such media to exchange. The social networking web site may allow the user to initiate an exchange. In an embodiment, the social networking web site may allow a user to initiate an exchange with another user regardless of whether the media is listed for exchange.

In an embodiment, the social networking web site may be configured to facilitate the exchange for a fee. For example, multiple users may provide a payment to a third party for the exchange of media between users. The social networking web site may receive compensation when a user exchanges one or more media with another user.

In an embodiment, the processor 240 of the server 210 may be further configured to make a determination of whether the appropriate value for the new media 215c is received based at least in part on the communication 230. For example, the processor 240 may determine that a transfer of the new media 215c may be in exchange for two or more media being disabled, a payment and one media being disabled, a credit, and/or the like. In an example embodiment, the processor 240 of the server 210 is configured to transfer the new media 215c to the electronic device 205. The processor of the electronic device 205 may be configured to receive the new media 215c, such as a new music file. A technical effect is to allow one or more users to exchange old media for new media.

In an embodiment, the processor of the electronic device 205 may be configured to activate the right, such as a DRM right, for the new media 215c, e.g., to make the new media operable or useable. In an alternative embodiment, the processor 240 of the server 210 may be configured to activate the right for the new media 215c prior to transferring of the new media 215c. It should be understood that example embodiments of the invention may employ multiple servers, such as server 210.

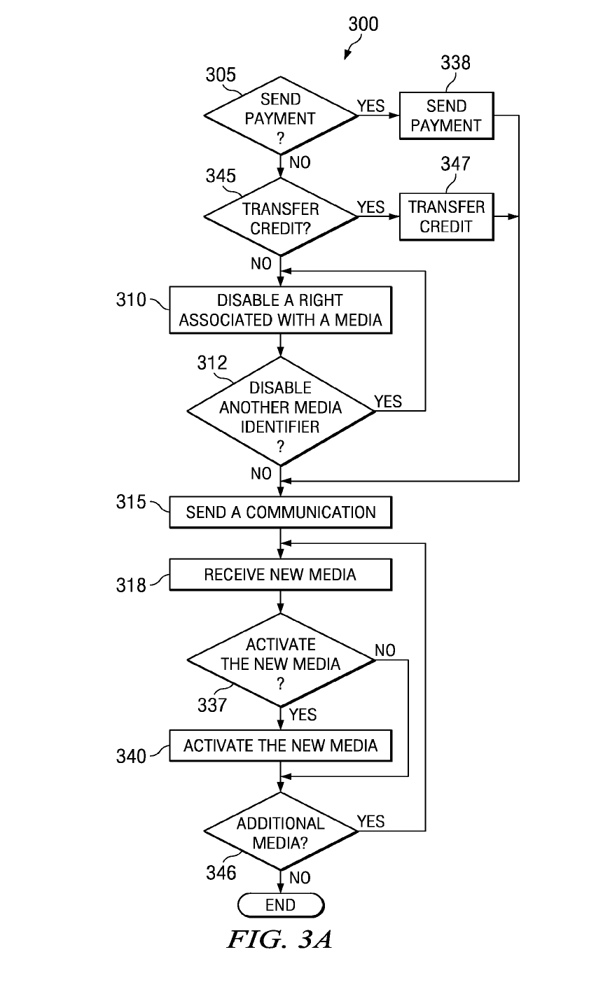

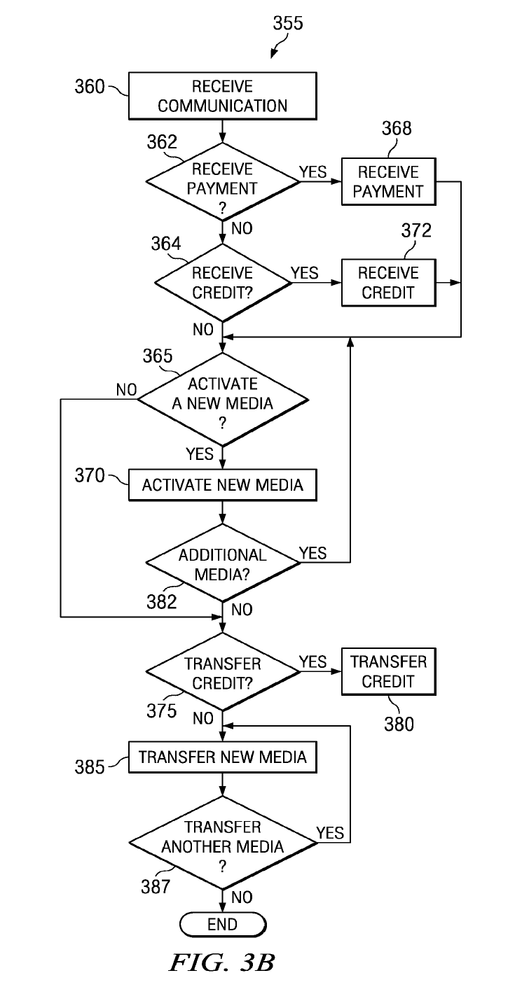

FIG. 3A is a flow diagram depicting an example method 300 for activating media in accordance with an example embodiment of the invention. Example method 300 may be performed by an electronic device, such as electronic device 205 of FIG. 2.

At 305, it is determined whether a payment is to be sent. For example, a processor, such as processor 20 of FIG. 1, determines if a user of the electronic device has provided a payment in exchange for a media. If at 305 it is determined that a payment is to be sent, then at 338 a payment is sent. In an example embodiment, the processor sends an electronic payment to a server, such as server 210 of FIG. 2. The example method 300 continues at 315.

If at 305 it is determined that no payment is to be sent, then at 345 it is determined whether a credit is to be transferred. For example, a processor, such as processor 20 of FIG. 1, determines if a user of the electronic device has indicated a credit is to be transferred in exchange for the media. If at 345 it is determined that a credit is to be transferred, then at 347 a credit is transferred. In an example embodiment, the processor of the electronic device transfers a credit for a new media to the server. The example method 300 continues at 315. If at 345 it is determined that no credit is to be transferred, then the example method 300 continues at 310.

At 310, a right associated with a media identifier is disabled. In an example embodiment, a user interface, such as user interface 220 of FIG. 2, receives a selection from a user on the electronic device comprising a media with a media identifier to exchange. The processor may disable a right, such as a DRM right, associated with the media identifier to render the media inoperable or unusable. At 312, it is determined whether another media identifier is to be disabled. In an example embodiment, a processor determines if the media identifier for a media is to be disabled, e.g., rendered inoperable. If at 312, it is determined that another media identifier is to be disabled, then the example method returns to 310. If at 312, it is determined that no additional media identifier is to be disabled, then the example method continues at 315.

At 315, a communication is sent. In an example embodiment, the communication comprises a new media name, a payment, a credit, a combination therefore, and/or the like. In an example embodiment, the processor sends a communication to the server regarding a media the user is interested in acquiring rights to. At 318, the new media is received. In an example embodiment, the processor receives a music file from the server.

At 337, it is determined whether the new media is to be activated. For example, the processor determines whether the new media has been activated, for example, by the server. In an example embodiment, if a new media has been activated by the server, then at 337 it is determined that the new media is not to be activated. The example method continues at 346.

If at 337, it is determined that the new media is to be activated then at 340 the new media is activated. In an example embodiment, the processor of the electronic device activates a DRM right for the new media. The example method continues at 346. At 346 it is determined whether there is an additional media to be received. In an example embodiment, the processor determines whether an additional media is to be received from the server, for example, based on a user request as indicated at block 315. If at 346 it is determined that there is an additional media to be received, then the example method 300 continues at 318. For example, the electronic device receives at least two media from the server as part of the exchange of a media, credit, payment, and/or the like. If at 346 it is determined that there is no additional media to be received, then the example method 300 ends. In an example embodiment, the electronic device receives no additional media from the server and as such the exchange is complete. A possible technical effect of the example embodiments is allowing a user to receive media without payment.

FIG. 3B is a flow diagram for transferring media in accordance with an example embodiment of the invention. Example method 355 may be performed by a server, such as server 210 of FIG. 2, for transferring media to another device, such as electronic device 205 of FIG. 2.

At 360, a communication is received. In an example embodiment, the communication comprises an identifier for a new media, a payment, a credit, a confirmation of disabling, and/or the like.

At 362, it is determined whether a payment is to be received. If at 362 it is determined that a payment is to be received, then at 368 a payment is received. In an example embodiment, the processor of a server, such as server 210 of FIG. 2, receives an electronic payment as part of the communication at block 360 from the electronic device in exchange for the new media. The example method continues at 365.

If at 362 it is determined that no payment is to be received, then at 364 it is determined whether a credit is to be received. In an example embodiment, the server receives a credit as part of the communication at block 360 from the electronic device. If at 364 it is determined that a credit is to be received, then at 372 a credit is received. In an example embodiment, the server receives a credit from the electronic device sufficient to exchange for the new media. For example, the server receives a credit comprising a value at least equivalent to the value of the new media. The example method continues at 365. If at 364 it is determined that no credit is to be transferred, then the example method 355 continues at 365.

At 365, it is determined whether the new media is to be activated. In an example embodiment, the server determines whether a right for the new media is to be activated prior to transferring the new media to the electronic device. For example, the server makes the determination by verifying that a credit, payment and/or confirmation of disabling of another media is part of the communication.

In an embodiment, the server may be pre-configured to activate or deactivate the new media based at least in part on a user preference. For example, the server may be configured to activate or deactivate each of the new media prior to transferring based on the user preference. In an alternative embodiment, the server may be configured to not activate any new media based on the user preference, e.g., activation is performed on the electronic device. If at 365, it is determined that the new media is to be activated then at 370 the new media is activated. In an example embodiment, a processor, such as processor 240 of FIG. 2, activates a DRM right for the new media.

At 382, it is determined whether an additional media is to be activated. In an example embodiment, the server determines whether at least two media are to be activated prior to transferring the media. If at 382 it is determined that there is an additional media to be activated, then the example method 355 returns to 365. If at 382 it is determined that there is no additional media to be activated, then the example method continues at 375.

If at 365, it is determined that the new media is not to be activated then the example method 355 continues at 375.

At 375, it is determined whether a credit is to be transferred. In an example embodiment, the server determines if the communication requests a credit in exchange for a media. If at 375 it is determined that a credit is to be transferred, then at 380 the credit is transferred. In an example embodiment, a processor, such as the processor of the server, transfers a credit for a media to an electronic device, such as electronic device 205. If at 375 it is determined that no credit is to be transferred, then at 385 the new media is transferred. In an example embodiment, the server transfers a new music file to the electronic device.

If at 387 it is determined that there is an additional media to be transferred, then the example method 355 returns to 385. For example, the server transmits at least two media to the electronic device as part of the exchange of disabling a media, a credit, a payment, a combination thereof and/or the like. If at 387 it is determined that there is no additional media to be transferred, then the example method 355 ends. In an example embodiment, the server transfers no additional media to the electronic device and as such the exchange is complete.

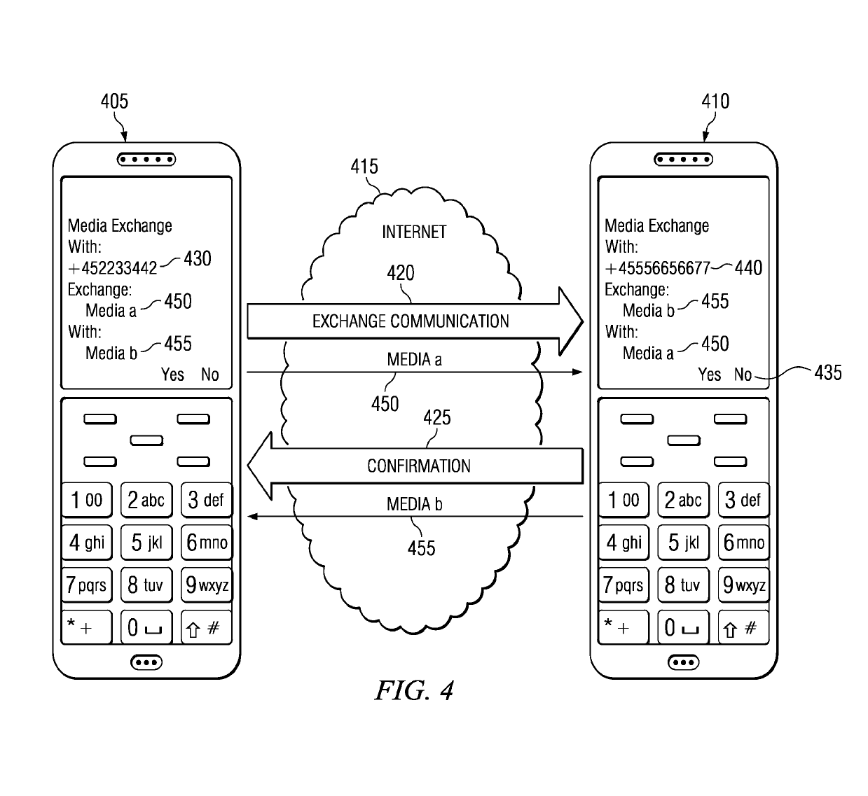

FIG. 4 is a block diagram depicting an electronic device and another electronic device operating in accordance with an example embodiment of the invention. In an example embodiment, the electronic device 405 and another electronic device 410 are in communication via a network, such as Internet 415. In an embodiment, the electronic device 405 may be similar to electronic device 205 and electronic device 410 may be similar to electronic device 205. In an alternative embodiment, the electronic device 405 and electronic device 410 may be different than electronic device 205.

In an embodiment, the electronic device 405 may comprise a processor and a user interface 430. Further, electronic device 410 may comprise a processor and a user interface 440. In an embodiment, user interfaces 430, 440 may be configured to allow a user to select a media to transfer and/or a media to receive. For example, the user interfaces 430, 440 may allow a user to select media 450 for transfer and media 455 to receive. In an embodiment, the processor of the electronic device 405 may send an exchange communication 420 to electronic device 410. In an example embodiment, the exchange communication 420 provides an identifier for one or more media to exchange on the electronic device 405 for one or more media on the electronic device 410. The processor of electronic device 410 may be configured to receive the exchange communication 420.

In an example embodiment, the user interface 440 of the electronic device 410 may display a confirmation interface 435 to allow a user to confirm the exchange. The electronic device 410 may send the confirmation 425 of the exchange to the electronic device 405. For example, the processor of electronic device 410 sends a confirmation 425 indicating acceptance or refusal of the exchange communication 420. In an embodiment, the confirmation 425 may be a BOOLEAN flag, for example, indicating yes or no.

In an example embodiment, the electronic device 405 is configured to receive the confirmation 425 of the exchange communication 420. In an alternative embodiment, the processor of electronic device 410 may not send a confirmation of the exchange communication 420. In an embodiment, the processor of the electronic device 405 may be configured to transfer media 450. The processor of electronic device 410 may be configured to receive media 450. Further, the processor of electronic device 410 may be configured to send media 455. The processor of the electronic device 405 may be configured to receive the media 455.

Consider the following example, a user of electronic device 405 may select a song for transfer using user interface 430. Further, the user of electronic device 405 may select a song to receive. The user may send the exchange communication 420 using the user interface 430. A user of electronic device 410 may receive the exchange communication 420. A user of the electronic device 410 confirms the exchange using the confirmation interface 435. The electronic device 410 sends the confirmation 425 of an exchange to the electronic device 405 using the user interface 440. The electronic device 410 may transmit media 455 and receive media 450. In this way, the electronic device 405 and electronic device 410 facilitate an exchange of medium 450, 455 based at least in part on the confirmation 425.

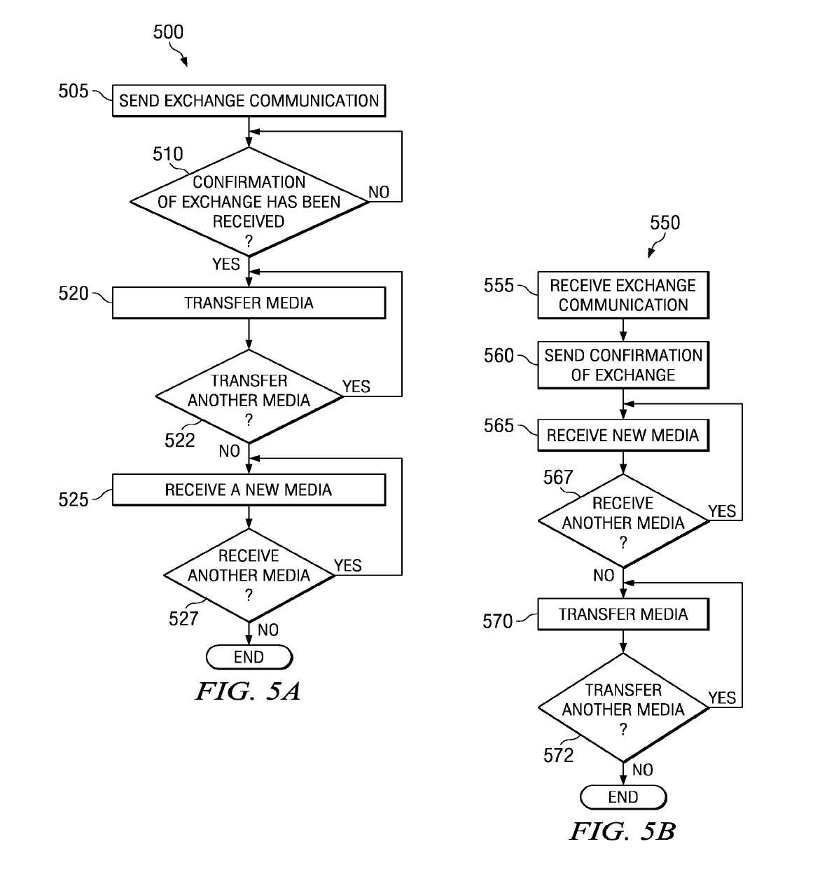

FIG. 5A is a flow diagram depicting an example method 500 for receiving media in accordance with an example embodiment of the invention. Example method 500 may be performed by an electronic device, such as electronic device 405 of FIG. 4.

At 505, an exchange communication, such as exchange communication 420 of FIG. 4, is sent. In an example embodiment, the exchange communication 420 provides an identifier for one or more media to exchange on an electronic device for one or more media on another electronic device. In an example embodiment, a processor, such as a processor of electronic device 405 of FIG. 4, sends the exchange communication to another electronic device, such as electronic device 410 of FIG. 4, to request a song.

At 510, it is determined whether a confirmation of an exchange has been received. In an example embodiment, the electronic device receives a confirmation from another electronic device. If at 510, it is determined that a confirmation has been received, then the example method continues at 520.

If at 510 it is determined that no confirmation of an exchange has been received, then the example method returns to 510.

At 520, the media is transferred. In an example embodiment, the electronic device, such as electronic device 405 of FIG. 4, transfers the media to another electronic device, such as electronic device 410 of FIG. 4. At 522 it is determined whether to transfer another media. If at 522 it is determined another media is to be transferred, then at 520 the media is transferred. In an example embodiment, the electronic device, such as electronic device 405 of FIG. 4, transfers another media as part of the exchange to another electronic device, such as electronic device 410 of FIG. 4. If at 522 it is determined that another media is not to be transferred, then the example method continues at 525.

At 525, a new media is received. In an example embodiment, the electronic device, such as electronic device 405 of FIG. 4, receives a new media from another electronic device, such as electronic device 410 of FIG. 4. At 527 it is determined whether to receive another media. If at 527 it is determined another media is to be received, then at 525 the media is received. In an example embodiment, the electronic device, such as electronic device 405 of FIG. 4, receives another media from another electronic device, such as electronic device 410 of FIG. 4. If at 527 it is determined that another media is not to be received, then the example method 500 ends. A possible technical effect of the example embodiment may be allowing multiple users to exchange media.

FIG. 5B is a flow diagram depicting another example method 550 for transferring media in accordance with an example embodiment of the invention. Example method 550 may be performed by an electronic device, such as another electronic device 410 of FIG. 4.

At 555, the exchange communication is received. In an example embodiment, a processor of the electronic device, such as electronic device 410 of FIG. 4, receives the exchange communication, such as exchange communication 420 of FIG. 4, from another electronic device, such as electronic device 405 of FIG. 4. At 560, a confirmation of the exchange is sent. In an example embodiment, a processor of the electronic device, such as electronic device 410 of FIG. 4, sends a confirmation of the exchange communication to another electronic device, such as electronic device 405 of FIG. 4.

At 565, new media is received. In an example embodiment, the electronic device, such as electronic device 410 of FIG. 4, receives new media from another electronic device, such as electronic device 405 of FIG. 4. At 567 it is determined whether to receive another media. If at 567 it is determined another media is to be received, then at 565 the media is received. In an example embodiment, the electronic device, such as electronic device 410 of FIG. 4, receives another media as part of the exchange from another electronic device, such as electronic device 405 of FIG. 4. If at 567 it is determined that another media is not to be received, then the example method continues at 570.

At 570, the media is transferred. In an example embodiment, the electronic device, such as electronic device 410 of FIG. 4, transfers media to another electronic device, such as electronic device 405 of FIG. 4. At 572 it is determined whether to transfer another media. If at 572 it is determined another media is to be transferred, then at 570 the media is transferred. In an example embodiment, the electronic device, such as electronic device 410 of FIG. 4, transfers another media as part of the exchange to another electronic device, such as electronic device 405 of FIG. 4. If at 572 it is determined that another media is not to be transferred, then the example method 550 ends.

It should be understood that receiving and/or transferring media at 565, 570 may be performed in any order. For example, 570 may be performed prior to 565 or 565 may be performed prior to 570. In an alternative embodiment, 565 and 570 may be performed concurrently.

Without in any way limiting the scope, interpretation, or application of the claims appearing below, it is possible that a technical effect of one or more of the example embodiments disclosed herein may be disabling a digital rights management right. Another possible technical effect of one or more of the example embodiments disclosed herein may be allowing a user to receive media without payment. Another technical effect of one or more of the example embodiments disclosed herein may be receiving payment for media. Another technical effect of one or more of the example embodiments disclosed herein may be allowing users to exchange media. Another technical effect of one or more of the example embodiments disclosed herein may be allowing users to exchange old media for new media.

Embodiments of the present invention may be implemented in software, hardware, application logic or a combination of software, hardware and application logic. The software, application logic and/or hardware may reside on an electronic device or a server. If desired, part of the software, application logic and/or hardware may reside on an electronic device and part of the software, application logic and/or hardware may reside on a server. The application logic, software or an instruction set is preferably maintained on any one of various conventional computer-readable media. In the context of this document, a “computer-readable medium” may be any media or means that can contain, store, communicate, propagate or transport the instructions for use by or in connection with an instruction execution system, apparatus, or device.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise any combination of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method of transferring media to a user device, comprising:
receiving a communication at a server, from a user device, the communication comprising a confirmation of the disabling of a digital rights management (DRM) right associated with a first media item at the user device;
determining, responsive to the communication, whether to activate a DRM right for a second media item for the user device;
responsive to the determining step, activating the DRM right associated with the second media item for the user device; and
transferring the second media item to the user device.

2. The method of claim 1, wherein the communication further comprises a media identifier for the second media item.

3. The method of claim 1, wherein the activating step is performed prior to the transferring step.

4. The method of claim 3, wherein the activating step is performed responsive to a user preference for the user device.

5. The method of claim 1, wherein the determining step comprises confirming that confirmation of the disabling of a DRM right associated with the first media item at the user device is included in the communication.

6. The method of claim 1, wherein the communication further comprises a payment;
and wherein the determining step comprises determining whether a value of the payment in combination with the confirmation of the disabling of a DRM right is sufficient for transfer of the second media item.

7. The method of claim 1, wherein the communication further comprises a credit;
and wherein the determining step comprises determining whether a value of the credit in combination with the confirmation of the disabling of a DRM right is sufficient for transfer of the second media item.

8. A server, comprising:
a transmitter for transmitting data to an external device;
a receiver for receiving data from an external device; and
a processor; and
at least one memory including computer program code operable to, when executed on the processor, causes the server to:
receive a communication from a user device via the receiver, the communication comprising a confirmation of the disabling of a digital rights management (DRM) right associated with a first media item at the user device;
determine, responsive to the communication, whether to activate a DRM right for a second media item for the user device;
responsive to the determining step, activate the DRM right associated with the second media item for the user device; and
transfer the second media item to the user device via the transmitter.

9. The server of claim 8, wherein the communication further comprises a media identifier for the second media item.

10. The server of claim 8, wherein the activating step is performed prior to the transferring step.

11. The server of claim 10, wherein the activating step is performed responsive to a user preference for the user device.

12. The server of claim 12, wherein the determining step comprises confirming that confirmation of the disabling of a DRM right associated with a first media item at the user device is included in the communication.

13. The server of claim 8, wherein the communication further comprises a payment;
and wherein the determining step comprises determining whether a value of the payment in combination with the confirmation of the disabling of a DRM right is sufficient for transfer of the second media item.

14. The server of claim 8, wherein the communication further comprises a credit;
and wherein the determining step comprises determining whether a value of the credit in combination with the confirmation of the disabling of a DRM right is sufficient for transfer of the second media item.
